(19) United States
(12) Patent Application Publication
(10) Pub. No.: US 2012/0040623 A1
(43) Pub. Date: Feb. 16, 2012

(54) METHOD AND SYSTEM FOR TRIGGERING CORRESPONDING FUNCTIONS OF ELECTRONIC DEVICES

(75) Inventors: Chih-Yuan Liu, Hsinchu County (TW); Kuo-Yu Chuang, Yilan County (TW); Yi-Lun Wen, Taoyuan County (TW)

(73) Assignee: INDUSTRIAL TECHNOLOGY RESEARCH INSTITUTE, Hsinchu (TW)

(21) Appl. No.: 13/207,393

(22) Filed: Aug. 10, 2011

Related U.S. Application Data
(60) Provisional application No. 61/373,261, filed on Aug. 12, 2010.

(30) Foreign Application Priority Data
Jun. 2, 2011 (TW) 100119407

(51) Int. Cl. H04W 24/00

(52) U.S. Cl. 455/67.13

(57) ABSTRACT

An exemplary method for triggering a corresponding function of an electronic device and a system using the same are provided. The method includes detecting radio signals between a first electronic device and a second electronic device, generating a radio signal quality evaluation value according to the characteristic of the radio signals and setting the function triggering module to one of the working modes according to the radio signal quality evaluation value.

### CROSS-REFERENCE TO RELATED APPLICATION

This application claims the priority benefits of U.S. provisional application Ser. No. 61/373,261, filed on Aug. 12, 2010 and Taiwan application serial no. 100119407, filed on Jun. 2, 2011. The entirety of each of the above-mentioned patent applications is hereby incorporated by reference herein and made a part of this specification.

### BACKGROUND OF THE DISCLOSURE

1. Field of the Disclosure

The disclosure relates to a method and a system for triggering a corresponding function of an electronic device.

2. Background

With development of technology, electronic products are widely used in people's daily life, though in many cases, some inadvertent negligence often results in unnecessary waste of energy. For example, when a user uses a computer at work and temporarily leaves for other matters, the computer is still maintained in a high power operating state.

According to experimental data of related research institutions, it is discovered that regardless of a desktop computer or a laptop computer, energy consumed by the display thereof occupies a large portion of the whole energy consumption of the computer. By turning off the unused or temporarily idle display or decreasing display brightness thereof, energy consumption can be effectively reduced, and a service life of the computer can be prolonged. Moreover, when the laptop computer is switched from a normal operating mode to a standby mode (which is also referred to as a sleep mode) with low power consumption, over 95% of the power consumption can be saved, and only several seconds are required to recover the computer from the standby mode to the normal operating mode. Moreover, in a current computer operating system, a time counting method is generally used as a reference for entering the standby mode. Namely, after the computer is not operated for a period of time (for example, from several minutes to several hours), a power module guides the computer to enter the standby mode. However, during such period of time, a plenty of power is consumed.

### SUMMARY OF THE DISCLOSURE

The disclosure is directed to a method and a system for triggering a corresponding function of an electronic device, by which power consumption of the electronic device is reduced.

An exemplary embodiment of the disclosure provides a method for triggering a corresponding function of an electronic device. The method includes detecting a plurality of radio signals between a first electronic device and a second electronic device; calculating and generating a radio signal quality evaluation value according to a characteristic of the radio signals; and triggering the first electronic device to execute a corresponding function or triggering to set the first electronic device to one of a plurality of working modes according to the radio signal quality evaluation value.

An exemplary embodiment of the disclosure provides a method for triggering a corresponding function of an electronic device. The method includes communicating with or receiving a message from at least one second electronic device through a radio communication module by a first electronic device; receiving coordinate information or information used for obtaining an approximate position from the second electronic device; triggering the first electronic device to execute a corresponding function or triggering to set the first electronic device to one of a plurality of working modes according to the coordinate information or the information used for obtaining the approximate position.

An exemplary embodiment of the disclosure provides a method for triggering a corresponding function of an electronic device, which is adapted for an electronic device having a radio communication module and a radio quality evaluation and function triggering module. The method of triggering a corresponding function of the electronic device includes linking the radio communication module of the electronic device with a radio device; receiving a control command from the radio device; and executing a corresponding function of the electronic device according to the control command.

An exemplary embodiment of the disclosure provides a system for triggering a corresponding function of an electronic device, which includes a radio quality evaluation module, a triggering action decision module and a function triggering module. The radio quality evaluation module is configured for detecting a plurality of radio signals between a first electronic device and a second electronic device, where the first electronic device and the second electronic device respectively have a radio communication module, and the first electronic device and the second electronic device are linked by radio. The function triggering module is disposed in the first electronic device. The radio quality evaluation module generates a radio signal quality evaluation value according to a signal characteristic of the radio signals, and the triggering action decision module sets the function triggering module of the first electronic device to one of a plurality of working modes, or guides the first electronic device to execute a corresponding function according to the radio signal quality evaluation value.

An exemplary embodiment of the disclosure provides a system for triggering a corresponding function of an electronic device, which includes a first electronic device, a second electronic device and at least one radio bridge. The first electronic device includes a radio communication module, a triggering action decision module and a function triggering module. The second electronic device is linked to the radio communication module of the first electronic device through the radio bridge, and the second electronic device generates coordinate information corresponding to the second electronic device or information used for obtaining an approximate position according to a plurality of radio signals come from the radio bridge. The triggering action decision module receives the coordinate information or the information used for obtaining the approximate position from the second electronic device through the radio communication module, and sets the function triggering module of the first electronic device to one of a plurality of working modes or guides the first electronic device to execute a corresponding function according to the coordinate information or the information used for obtaining the approximate position.

An exemplary embodiment of the disclosure provides a system for triggering a corresponding function of an electronic device, which includes a first electronic device and a second electronic device. The first electronic device includes a radio communication module, a triggering action decision module and a function triggering module. The second electronic device is linked to the radio communication module of the first electronic device. The triggering action decision module receives a control command from the second electronic device through the radio communication module, and instructs the function triggering module to execute a corresponding function of the first electronic device according to the control command.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification.

The drawings illustrate embodiments of the disclosure and, together with the description, serve to explain the principles of the disclosure.

FIG. 1 is an operational schematic diagram of a system for triggering a corresponding function of an first electronic device according to an exemplary embodiment of the disclosure.

FIG. 2 is a schematic block diagram of the first electronic device according to the exemplary embodiment of FIG. 1.

FIG. 3A is a schematic diagram of switching working modes according to the exemplary embodiment of FIG. 1 and FIG. 2.

FIG. 3B is a schematic diagram of switching working modes according to the exemplary embodiment of FIG. 1 and FIG. 2.

FIG. 4 is a flowchart illustrating a method for triggering a corresponding function of an first electronic device according to the exemplary embodiment of FIG. 1 and FIG. 2.

FIG. 5 is an operational schematic diagram of a system for triggering a corresponding function of an first electronic device according to another exemplary embodiment of the disclosure.

FIG. 6 is an operational schematic diagram of a system for triggering a corresponding function of an first electronic device according to another exemplary embodiment of the disclosure.

FIG. 7 is a block schematic diagram of the first electronic device of the exemplary embodiment of FIG. 6.

FIG. 8 is a block schematic diagram of a second electronic device of the exemplary embodiment of FIG. 6.

FIG. 9 is a flowchart illustrating a method for triggering a corresponding function of an first electronic device according to the exemplary embodiment of FIG. 6, FIG. 7 and FIG. 8.

FIG. 10 is a diagram of a system for triggering a corresponding function of an first electronic device according to still another exemplary embodiment of the disclosure.

FIG. 11 is a block schematic diagram of the first electronic device of the exemplary embodiment of FIG. 10.

FIG. 12 is a flowchart illustrating a method for triggering a corresponding function of an first electronic device according to the exemplary embodiment of FIG. 10 and FIG. 11.

FIG. 13 is a flowchart illustrating a method for triggering a corresponding function of an first electronic device according to another exemplary embodiment of the disclosure.

### DETAILED DESCRIPTION OF DISCLOSED EMBODIMENTS

Several exemplary embodiments are provided to describe methods and systems of triggering a corresponding function of an electronic device, in which an first electronic device and/or a portable second electronic device evaluate radio quality of radio signals transmitted there between or an influence degree of a radio channel on the radio signals, and the first electronic device or the portable second electronic device guides the first electronic device to enter a suitable working mode or triggers the first electronic device to execute a corresponding function according to an evaluation result. In the methods provided by the disclosure, by analysing radio quality of radio signals sent by a second electronic device carried by a user, it can be determined whether the user leaves a computer, and the computer is guided to enter a low power consumption state (for example, a sleep mode) when it is determined that the user leaves the computer, so as to save the power consumption. Several exemplary embodiments are provided below with reference of figures to describe the disclosure in detail.

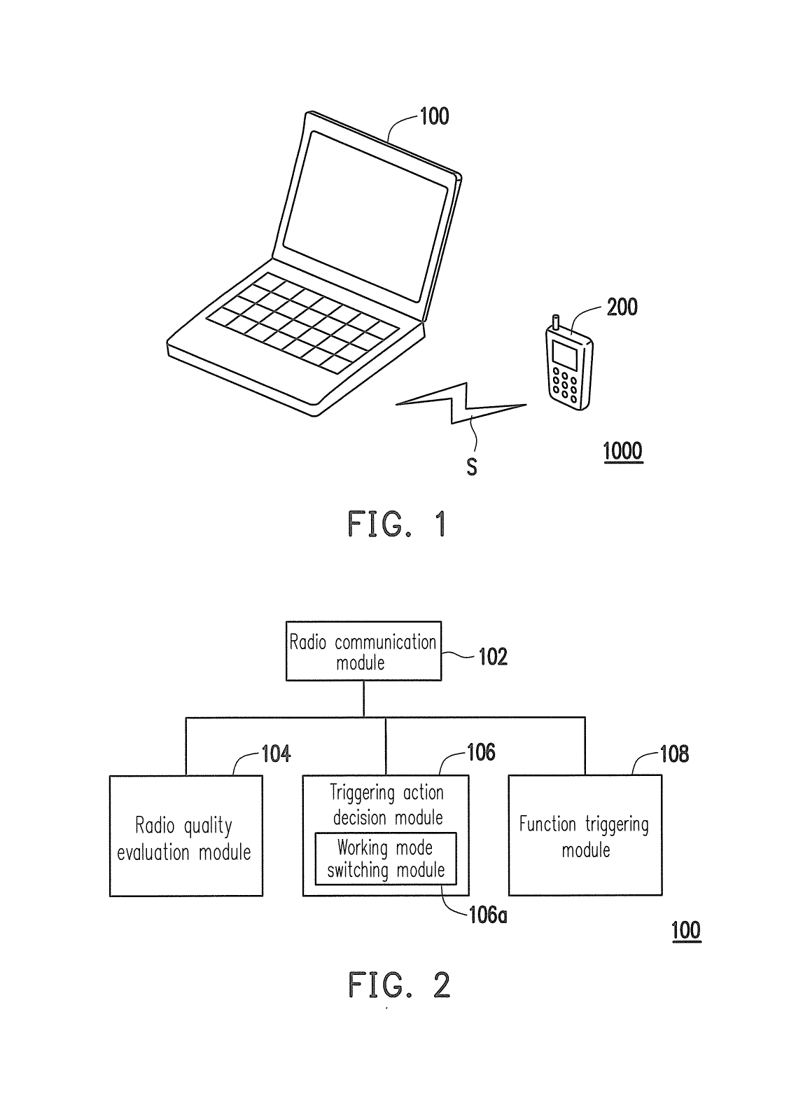

FIG. 1 is an operational schematic diagram of a system for triggering a corresponding function of an first electronic device.

Referring to FIG. 1, a system 1000 includes an first electronic device 100 and a second electronic device 200.

The first electronic device 100 can be operated in a plurality of working modes and can communicate with the second electronic device 200 or capture radio signals from the second electronic device 200. For example, in the present exemplary embodiment, the first electronic device 100 is a computer. However, it should be noticed that the present disclosure is not limited thereto, and the first electronic device 100 can be any electronic device capable of linking the second electronic device 200 or capturing the radio signals from the second electronic device 200.

The second electronic device 200 is used to send the radio signals to the first electronic device 100, or the second electronic device 200 is capable of capturing and analysing radio signals sent by the first electronic device 100, and after the analysis, the second electronic device 200 can transmit an analysing result, related information or a control command, etc. to the first electronic device 100. For example, in the present exemplary embodiment, the second electronic device 200 is a mobile phone. However, it should be noticed that the disclosure is not limited thereto, and the second electronic device 200 can be any portable electronic device capable of linking the first electronic device 100. For example, in the present exemplary embodiment, the first electronic device 100 and the second electronic device 200 can be linked through a bluetooth communication protocol or a wireless fidelity (Wi-Fi) communication protocol.

The first electronic device 100 receives a radio signal S from the second electronic device 200 and switches a state thereof to a suitable working mode according to information in the radio signal S or the characteristic of the radio signal S (for example, a received signal strength indication (RSSI) of the radio signal S, or a signal-to-noise ratio (SNR).

For example, when the first electronic device 100 determines that an evaluation value of the radio signals sent by the second electronic device 200 is greater than a first threshold, the first electronic device 100 enters a normal working mode. Moreover, when the first electronic device 100 determines that evaluation value of the radio signals sent by the second electronic device 200 is not greater than the first threshold, the first electronic device 100 enters a low power consumption mode. A commonly used evaluation method may be performed by calculating an average or a weighted average of a plurality of RSSIs, or by detecting continuous or specifically distributed RSSIs all satisfying a specific condition (for example, three continuous legitimate RSSIs are all greater than a specific value), etc., where the term “legitimate” includes a communication method complied with a specification of the radio communication protocol, or a given condition (for example, the radio signals captured within a time limit are legitimate, and the radio signals captured beyond the time limit are illegitimate).

FIG. 2 is a schematic block diagram of the first electronic device 100 according to the exemplary embodiment of FIG. 1.

Referring to FIG. 2, the first electronic device 100 includes a radio communication module 102, a radio quality evaluation module 104, a triggering action decision module 106 having a working mode switching module 106a, and a function triggering module 108.

The radio communication module 102 is configured to receive the radio signals sent by the second electronic device 200, and the radio communication module 102 may also have capability for communicating with a radio communication module of the second electronic device 200. In the present exemplary embodiment, the radio communication module 102 can be built in the first electronic device 100 or connected to the first electronic device 100 through a cable connection port (for example, a universal serial bus (USB), or a wireless connection port (for example, infrared, GPRS/3G/3.5G/3.75G, Wi-Fi or bluetooth, etc.).

In the present exemplary embodiment, the radio communication module 102 is complied with the bluetooth specification or the Wi-Fi specification. However, the present disclosure is not limited thereto, and the radio communication module 102 can also be complied with a radio frequency identification (RFID) technical specification or other radio specifications.

The radio quality evaluation module 104 is configured for detecting a plurality of the radio signals between the first electronic device 100 and the second electronic device 200, and generates a radio signal quality evaluation value according to the characteristic of the radio signals. The triggering action decision module 106 drives the function triggering module 108 of the first electronic device 100 to set the first electronic device 100 to one of a plurality of working modes, or guides the first electronic device 100 to execute a corresponding function according to the radio signal quality evaluation value generated by the radio quality evaluation module 104. For example, in the present exemplary embodiment, the working mode switching module 106a of the triggering action decision module 106 manages a power supply of the first electronic device 100 according to an advanced configuration and power interface (ACPI) specification.

According to the ACPI specification, the working modes of the first electronic device 100 can be divided into a normal working mode G0, multiple sleep modes G1, a soft off mode G2 and a mechanical off mode G3.

In the normal working mode (which is referred to as the S0 mode hereinafter), the working mode switching module 106a of the triggering action decision module 106 drives the function triggering module 108 to control all devices of the first electronic device 100 to normally operate.

In the sleep mode, the working mode switching module 106a of the triggering action decision module 106 drives the function triggering module 108 to control the first electronic device 100 to enter a standby state. In the ACPI specification, the sleep mode is further divided in to an S1 mode, an S2 mode, an S3 mode and an S4 mode.

In the soft off mode (which is referred to as an S5 mode hereinafter), the working mode switching module 106a of the triggering action decision module 106 drives the function triggering module 108 to maintain a minimum power, so that the first electronic device 100 can be woke up through a keyboard, a modem or a universal serial bus (USB) device.

In the mechanical off mode (which is referred to as an S6 mode), the working mode switching module 106a of the triggering action decision module 106 drives the function triggering module 108 to completely cut off the power supply.

The working mode switching module 106a of the triggering action decision module 106 is configured for identifying the radio signal quality evaluation value of the radio signals received from the second electronic device 200, and setting the function triggering module 108 to the corresponding working mode according to the radio signal quality evaluation value. In the present disclosure, the radio quality evaluation module 104, the triggering action decision module 106 having the working mode switching module 106a, and the function triggering module 108 can be implemented by hardware circuits or computer programs.

When the system 1000 is initialised, the second electronic device 200 is linked to the first electronic device 100. Then, the radio quality evaluation module 104 detects the radio signals sent by the linked second electronic device 200. Herein, the term “link” refers to that at least one party authenticates another party or refers to mutual authentications. For example, when the second electronic device 200 and the first electronic device 100 are communicated through the bluetooth protocol, the link between the second electronic device 200 and the first electronic device 100 is complied with the bluetooth protocol, and the radio quality evaluation module 104 identifies the radio signals sent by the second electronic device 200 according to a bluetooth identification code corresponding to the second electronic device 200. For another example, when the second electronic device 200 and the first electronic device 100 are communicated through the Wi-Fi protocol, the second electronic device 200 and the first electronic device 100 can be linked through identification of a media access control (MAC) address, values of registers in the second electronic device 200 and the first electronic device 100, device IDs or any information used for identifying IDs, and the radio quality evaluation module 104 identifies the radio signals sent by the second electronic device 200 according to the MAC address corresponding to the second electronic device 200. Namely, the radio quality evaluation module 104 only detects the radio signals of the second electronic device 200 that has been ever linked, so that the ID of the user that actuates the triggering action decision module 106 to switch the working modes can be confirmed.

The radio quality evaluation module 104 obtains radio signal quality from the detected radio signals, and the triggering action decision module 106 drives the function triggering module 108 to set the first electronic device 100 to the corresponding working mode according to the radio signal quality or a calculated evaluation result.

For example, the radio quality evaluation module 104 calculates the radio signal quality evaluation value according to a following equation (1) or equation (2), where the equation (1) is used to calculate a radio signal strength of a direct link, and the equation (2) is used to calculate a radio signal strength of multiple links or routes:

$${S}_{t}^{i} = \frac{1}{p} {\sum }_{j = 1}^{p} {S}_{t}^{i} ( j ) \qquad ( 1 )$$

Where Sₜⁱ represents an average of signal strength parameters (SSPs) received within a t^{th} second, p represents the number of the SSPs obtained per second, and Sₜⁱ (j) represents a normalized value of a j^{th} SSP in the t^{th} second (i.e. Sₜⁱ(j) is between 0 and 1), where the SSP value can also be replaced by the RSSI value.

$${ACL}_{r} = {Γ}_{∀ i ∈ {P}_{r}} {L}_{i} ( t ) \qquad ( 2 )$$

Where ACLᵣ represents an accumulated link quality value, i represents a link in the path, and Pᵣ represents a link set of all links including the path.

In the present exemplary embodiment, the radio quality evaluation module 104 generates the radio signal quality evaluation value according to the radio signal strength (i.e. the radio signal strength calculated according to the aforementioned equation (1) or equation (2)). For example, the radio quality evaluation module 104 sets the radio signal quality evaluation value to a corresponding value according to the radio signal strength. Moreover, each working mode of the first electronic device 100 is set to correspond to a radio signal quality evaluation value range. The working mode switching module 106a of the triggering action decision module 106 drives the function triggering module 108 to set the first electronic device 100 to a suitable working mode according to the radio signal quality evaluation value.

For example, the working mode switching module 106a of the triggering action decision module 106 divides the evaluation result of the radio signals into several regions of a strong RSSI region, a hysteresis region, a weak RSSI region and a disconnection region.

In an example that the second electronic device 200 departs from the first electronic device 100, when the second electronic device 200 is in the strong RSSI region, the first electronic device 100 is in a normal standby mode, and now the windows ACPI is allowed to be normally operated. When the second electronic device 200 enters the hysteresis region, the first electronic device 100 is still in the normal standby mode, and only when the second electronic device 200 leaves the hysteresis region, for example, the second electronic device 200 enters the weak RSSI region, the first electronic device 100 is adjusted from the standby mode to another predetermined mode (for example, the screen is turned off to save power; a screen lock function built in the Windows operating system or a screen lock function provided by other software or hardware is activated; and the aforementioned items can be adjusted or individually used). Moreover, when the second electronic device 200 further leaves the first electronic device 100 and enters the disconnection region, the first electronic device 100 enters the sleep mode (or other predetermined modes or the low power consumption mode).

In an example that the second electronic device 200 approaches the first electronic device 100, when the second electronic device 200 is in the disconnection region, the first electronic device 100 is in the sleep mode (or other predetermined modes or the low power consumption mode). When the second electronic device 200 enters the weak RSSI region, the first electronic device 100 is triggered to a specific predetermined mode (for example, wakeup, the screen is maintained locked, or the screen is turned off, etc., and the above items can be separately used or used in collaboration, or other states can be additionally set, which is not limited by the disclosure). When the second electronic device 200 is close to the hysteresis region, the first electronic device 100 is still maintained to the state as if the mobile phone is in the weak RSSI region, and only when the mobile phone enters the strong RSSI region, the computer is unlocked or switched to the normal standby mode.

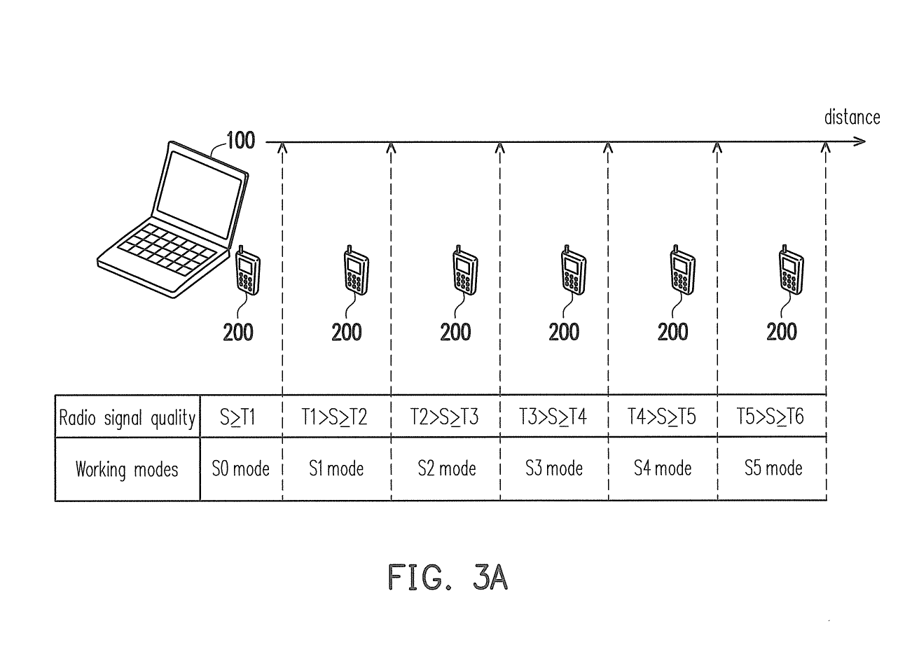

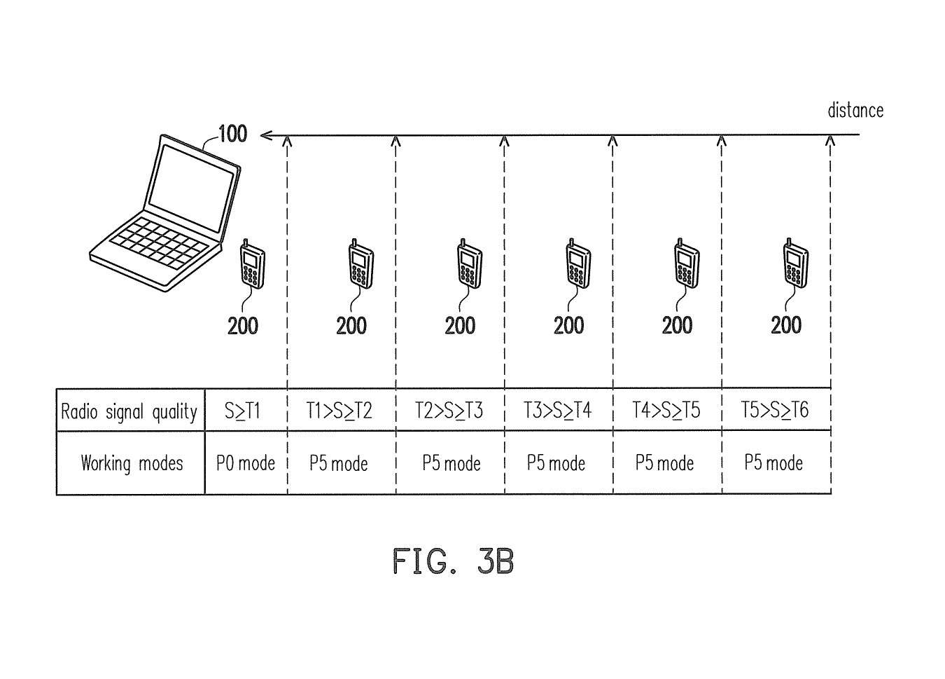

FIG. 3A is a schematic diagram of switching working modes according to the exemplary embodiment of FIG. 1 and FIG. 2, in which when the second electronic device 200 departs from the first electronic device 100, a process that the working mode switching module 106a of the triggering action decision module 106 switches the working modes according to the radio signal quality evaluation value between the first electronic device 100 and the second electronic device 200 is illustrated.

Referring to FIG. 3A, when the radio signal quality evaluation value between the first electronic device 100 and the second electronic device 200 is greater than or equal to a first threshold value T1, the working mode switching module 106a of the triggering action decision module 106 drives the function triggering module 108 to set the first electronic device 100 to the S0 mode.

When the radio signal quality evaluation value between the first electronic device 100 and the second electronic device 200 is smaller than the first threshold value T1 and is not smaller than a second threshold value T2, the working mode switching module 106a of the triggering action decision module 106 drives the function triggering module 108 to set the first electronic device 100 to the S1 mode.

When the radio signal quality evaluation value between the first electronic device 100 and the second electronic device 200 is smaller than the second threshold value T2 and is not smaller than a third threshold value T3, the working mode switching module 106a of the triggering action decision module 106 drives the function triggering module 108 to set the first electronic device 100 to the S2 mode.

When the radio signal quality evaluation value between the first electronic device 100 and the second electronic device 200 is smaller than the third threshold value T3 and is not smaller than a fourth threshold value T4, the working mode switching module 106a of the triggering action decision module 106 identifies that a relative displacement of the second electronic device 200 and the first electronic device 100 is within a fourth displacement range, and drives the function triggering module 108 to set the first electronic device 100 to the S3 mode.

When the radio signal quality evaluation value between the first electronic device 100 and the second electronic device 200 is smaller than the fourth threshold value T4 and is not smaller than a fifth threshold value T5, the working mode switching module 106a of the triggering action decision module 106 drives the function triggering module 108 to set the first electronic device 100 to the S4 mode.

When the radio signal quality evaluation value between the first electronic device 100 and the second electronic device 200 is smaller than the fifth threshold value T5 and is not smaller than a sixth threshold value T6, the working mode switching module 106a of the triggering action decision module 106 drives the function triggering module 108 to set the first electronic device 100 to the S5 mode.

According to the above descriptions, when the user carrying the second electronic device 200 gradually departs from the first electronic device 100, the working mode switching module 106a of the triggering action decision module 106 sequentially guides the first electronic device 100 to the suitable low power consumption mode according to the radio signal quality evaluation value between the first electronic device 100 and the second electronic device 200, so as to save power.

In FIG. 3A, although the working modes are divided into six modes of the S0 mode, the S1 mode, the S2 mode, the S3 mode, the S4 mode and the S5 mode, the number of the working modes is not limited thereto, and in another exemplary embodiment, the number of the working modes can be arbitrary.

Similarly, when the user carrying the second electronic device 200 gradually approaches the first electronic device 100, the working mode switching module 106a of the triggering action decision module 106 can also wakeup the first electronic device 100. FIG. 3B is a schematic diagram of switching working modes according to the exemplary embodiment of FIG. 1 and FIG. 2, in which when the second electronic device 200 approaches the first electronic device 100, a process that the working mode switching module 106a of the triggering action decision module 106 wakes up the first electronic device 100 according to the radio signal quality evaluation value between the first electronic device 100 and the second electronic device 200 is illustrated.

Referring to FIG. 3B, in an example that the first electronic device 100 is switched to the P5 mode due to departure of the second electronic device 200, and the second electronic device 200 gradually approaches the first electronic device 100, the working mode switching module 106a of the triggering action decision module 106 may identify that the second electronic device 200 gradually approaches the first electronic device 100 by detecting that the radio signal quality evaluation value between the first electronic device 100 and the second electronic device 200 is gradually increased. When the radio signal quality evaluation value between the first electronic device 100 and the second electronic device 200 is greater than or equal to the first threshold value T1, the working mode switching module 106a of the triggering action decision module 106 drives the function triggering module 108 to set the first electronic device 100 to a P0 mode, so as to wakeup the first electronic device 100.

Similarly, in FIG. 3B, although the working modes are divided into two modes of the P0 mode and the P5 mode, the number of the working modes is not limited thereto, and in another exemplary embodiment, the number of the working modes can be arbitrary.

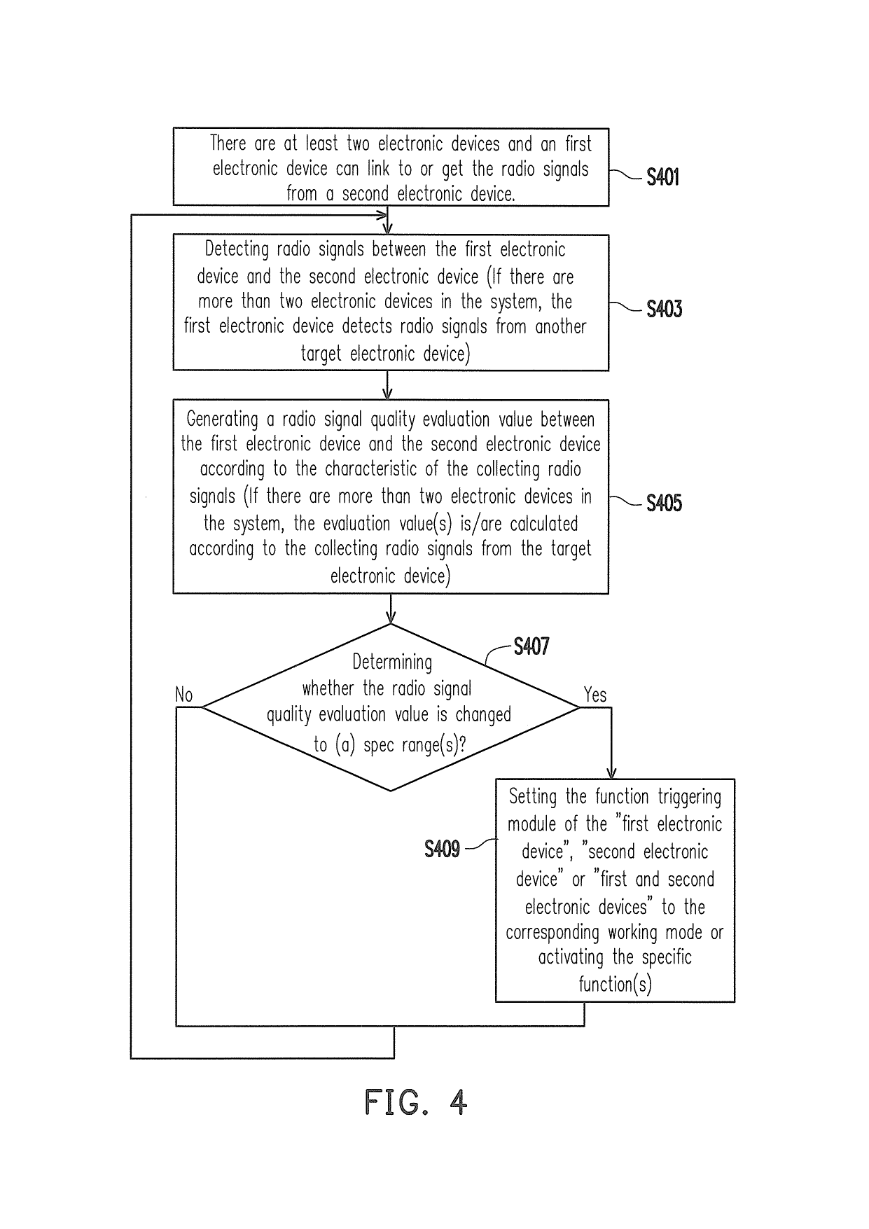

FIG. 4 is a flowchart illustrating a method of triggering a corresponding function of an first electronic device according to the exemplary embodiment of FIG. 1 and FIG. 2.

Referring to FIG. 4, in step S401, the radio communication module 102 of the first electronic device 100 is linked to the second electronic device 200.

In step S403, the radio signals between the first electronic device 100 and the second electronic device 200 are detected. In step S405, a radio signal quality evaluation value between the first electronic device 100 and the second electronic device 200 is generated according to the characteristic of the radio signals between the first electronic device 100 and the second electronic device 200.

In step S407, it is determined whether the radio signal quality evaluation value between the first electronic device 100 and the second electronic device 200 is changed to another range.

If the radio signal quality evaluation value between the first electronic device 100 and the second electronic device 200 is changed to the other range, in step S409, the function triggering module 108 of the first electronic device 100 is set to the corresponding working mode. The method of setting the corresponding working mode has been described in detail with reference of FIG. 3A and FIG. 3B, so that details thereof are not repeated.

If it is determined that the radio signal quality evaluation value between the first electronic device 100 and the second electronic device 200 is not changed to the other range, or after the step S409 is executed, the flow is returned to the step S403 to continually detect the radio signals between the first electronic device 100 and the second electronic device 200.

In the step S405, the radio quality evaluation module 104 generates the radio signal quality evaluation value according to the radio signal strength. However, the present disclosure is not limited thereto, and the radio quality evaluation module 104 can also generate the radio signal quality evaluation value between the first electronic device 100 and the second electronic device 200 according to other information extracted from the radio signals.

For example, in another exemplary embodiment, the radio quality evaluation module 104 generates the radio signal quality evaluation value according to a variation trend of the continuously detected radio signal strengths. For example, the radio quality evaluation module 104 calculates the variation trend of the radio signal strengths within a period of time in an average or a weight average manner. Moreover, the radio quality evaluation module 104 generates the radio signal quality evaluation value between the first electronic device 100 and the second electronic device 200 according to the calculated variation trend. For example, when the variation trend indicates that the radio signal strengths are gradually weakened, it represents that the second electronic device 200 gradually departs from the first electronic device 100. In some cases or in case that a specific radio communication protocol is used, in order to ensure the radio signals received by a receiver reaching certain quality, a transmitter can improve a transmitting power, and a parameter of increasing the transmitting power can also serve as one of the parameters for evaluating or calculating the radio signal quality. Therefore, the working mode switching module 106a of the triggering action decision module 106 sets the function triggering module 108 to the low power consumption mode. When the variation trend indicates that the radio signal strengths are gradually increased, it represents that the second electronic device 200 gradually approaches the first electronic device 100. Therefore, the working mode switching module 106a of the triggering action decision module 106 sets the function triggering module 108 to the normal working mode when the radio signal quality evaluation value between the first electronic device 100 and the second electronic device 200 is greater than the first threshold value.

Moreover, in another exemplary embodiment, the working mode switching module 106a of the triggering action decision module 106 can also set the working mode according to a radio signal beacon time density. For example, the radio quality evaluation module 104 can generate the radio signal quality evaluation value between the first electronic device 100 and the second electronic device 200 according to the number of beacons received per second. For example, the radio signal has an attenuation phenomenon during transmission, especially when the receiver is located at the edge of a signal coverage range of the transmitter, and now some signals are missed or cannot be correctly received due to unstable signal strength. Now, the number of radio signal beacons received by the receiver (or a beacon number per unit time) is probably less than the number of the radio signal beacons sent by the transmitter. Therefore, when the second electronic device 200 is closer to the first electronic device 100, since the missed beacons are relatively less, the time density of the received beacon is higher. When the second electronic device 200 is far away from the first electronic device 100, the time density of the received beacon is lower. Therefore, similar as that shown in FIGS. 3A and 3B, the radio signal quality evaluation value between the first electronic device 100 and the second electronic device 200 can be generated according to the beacon time density, and then the function triggering module 108 is driven to set the first electronic device 100 to one of the working modes.

Moreover, in another exemplary embodiment, the radio quality evaluation module 104 calculates a variation trend of the beacon time densities within a period time according to the continuously received radio signal beacon time density information. For example, the radio quality evaluation module 104 calculates the variation trend of the beacon time densities within a period time in an average or weighted average manner. Moreover, the working mode switching module 106a sets the first electronic device 100 to the corresponding working mode according to the calculated variation trend. For example, when the variation trend indicates that the beacon time densities are gradually decreased, it represents that the second electronic device 200 gradually departs from the first electronic device 100. Therefore, the working mode switching module 106a of the triggering action decision module 106 drives the function triggering module 108 to set the first electronic device 100 to the low power consumption mode. When the variation trend indicates that the beacon time densities are gradually increased, it represents that the second electronic device 200 gradually approaches the first electronic device 100. Therefore, the working mode switching module 106a of the triggering action decision module 106 drives the function triggering module 108 to set the first electronic device 100 to the normal working mode.

In another exemplary embodiment, when the second electronic device 200 is linked to the radio communication module 102 of the first electronic device 100, the working mode switching module 106a of the triggering action decision module 106 further processes and records a best radio signal quality between the first electronic device 100 and the second electronic device 200. For example, the radio signal quality measured when the user carrying the second electronic device sits near the first electronic device (for example, sits in front of the computer) is defined as a near-end high quality radio link evaluation result, and such evaluation result can be different in case of different utilization environments. Herein, the best radio signal quality can be used to specify or establish a high quality radio range. Moreover, when the working mode switching module 106a of the triggering action decision module 106 detects that the user is operating the first electronic device 100, it may re-measure, update or record the best radio signal quality between the first electronic device 100 and the second electronic device 200. The newly obtained evaluation result can be used to totally replace or partially replace the existing evaluation result, where the partial replacement is used to avoid or reduce an influence of a special radio signal quality evaluation result on an error evaluation of a real objective situation.

In the present exemplary embodiment, the radio quality evaluation module 104 repeatedly detects the radio signals between the first electronic device 100 and the second electronic device 200 according to a fixed monitoring frequency, so as to generate the radio signal quality evaluation value. However, the present disclosure is not limited thereto, and in another exemplary embodiment, the radio quality evaluation module 104 can also detect the radio signals between the first electronic device 100 and the second electronic device 200 according to a varied monitoring frequency. For example, the radio quality evaluation module 104 can adjust the monitoring frequency according to a measuring result (for example, a variation magnitude) of a G-sensor, a gyro or an E-compass of the second electronic device 200, or adjust the monitoring frequency according to a signal of a keyboard or a mouse of the first electronic device 100.

In the present exemplary embodiment, the operations of monitoring the radio signal strengths between the first electronic device 100 and the second electronic device 200 and generating the radio signal quality evaluation value according to the radio signal strengths between the first electronic device 100 and the second electronic device 200 are carried out by the radio quality evaluation module 104 of the first electronic device 100, and the triggering action decision module 106 of the first electronic device 100 drives the function triggering module 108 to set the first electronic device 100 to the corresponding working mode or execute a corresponding function.

However, the present disclosure is not limited thereto, and in another exemplary embodiment, the operations of monitoring the radio signal strengths between the first electronic device 100 and the second electronic device 200 and generating the radio signal quality evaluation value according to the radio signal strengths between the first electronic device 100 and the second electronic device 200 can also be executed by the second electronic device 200. Namely, the radio quality evaluation module 104 can also be disposed in the second electronic device 200, and the second electronic device 200 is used to generate the radio signal quality evaluation value.

Moreover, in another exemplary embodiment, the radio quality evaluation module 104 and the triggering action decision module 106 can also be disposed in the second electronic device 200, and the second electronic device 200 is used to generate the radio signal quality evaluation value, and drive the function triggering module 108 to set the first electronic device 100 to the corresponding working mode or execute a corresponding function according to the generated radio signal quality evaluation value.

In the exemplary embodiment of FIG. 1 and FIG. 2, the first electronic device directly receives the radio signals from the second electronic device, and generates the radio signal quality evaluation value according to the information of the received radio signals (for example, the radio signal strengths, the radio signal beacon time densities or a control command). In another exemplary embodiment, the first electronic device can also receive the radio signals from the second electronic device through a radio bridge. Namely, the radio signals of the second electronic device are transmitted to the first electronic device through the radio bridge.

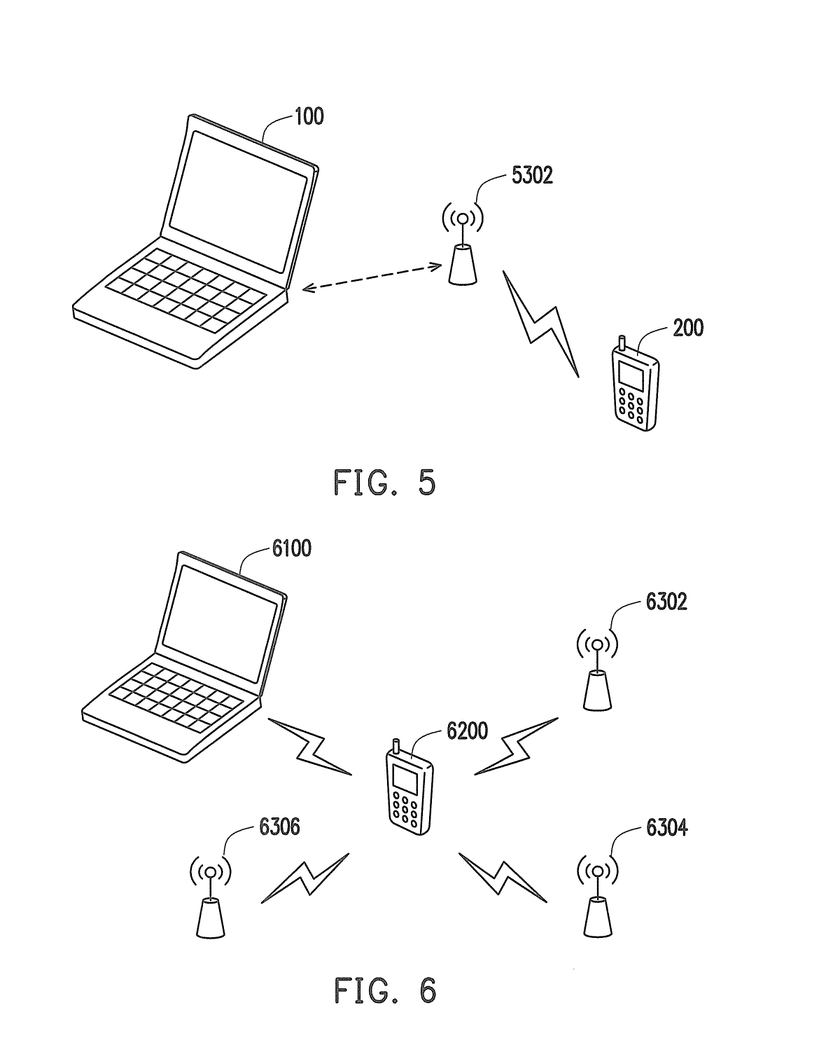

FIG. 5 is an operational schematic diagram of a system for triggering a corresponding function of an electronic device according to another exemplary embodiment of the disclosure.

Referring to FIG. 5, the system 5000 includes the first electronic device 100, the second electronic device 200 and a radio bridge 5302.

In the present exemplary embodiment, the radio bridge 5302 is configured for receiving radio signals sent by the second electronic device 200 and transmitting the radio signals to the first electronic device 100.

The same to the exemplary embodiment of FIG. 1, the first electronic device 100 generates the radio signal quality evaluation value according to the information in the radio signals, and enters a corresponding working mode according to the radio signal quality evaluation value. Namely, the radio quality evaluation module 104 obtains the radio signal strengths between the first electronic device 100 and the second electronic device 200, and generates the radio signal quality evaluation value according to the radio signal strengths, and the triggering action decision module 106 drives the function triggering module 108 to set the first electronic device 100 to the corresponding working mode according to the radio signal quality evaluation value (as that shown in FIG. 3).

In the present exemplary embodiment, the first electronic device 100 and the radio bridge 5302 can be connected through a wireless channel or a cable channel. Namely, when the radio signal of the second electronic device 200 is received, the radio bridge 5302 may transmit related information of the radio signal to the first electronic device 100 through the wireless channel or the cable channel.

In another exemplary embodiment, the first electronic device enters a suitable working mode according to coordinate information received from the second electronic device.

FIG. 6 is an operational schematic diagram of a system for triggering a corresponding function of an electronic device according to another exemplary embodiment of the disclosure.

Referring to FIG. 6, the system 6000 includes an first electronic device 6100, a second electronic device 6200 and a radio bridge 6302, a radio bridge 6304 and a radio bridge 6306.

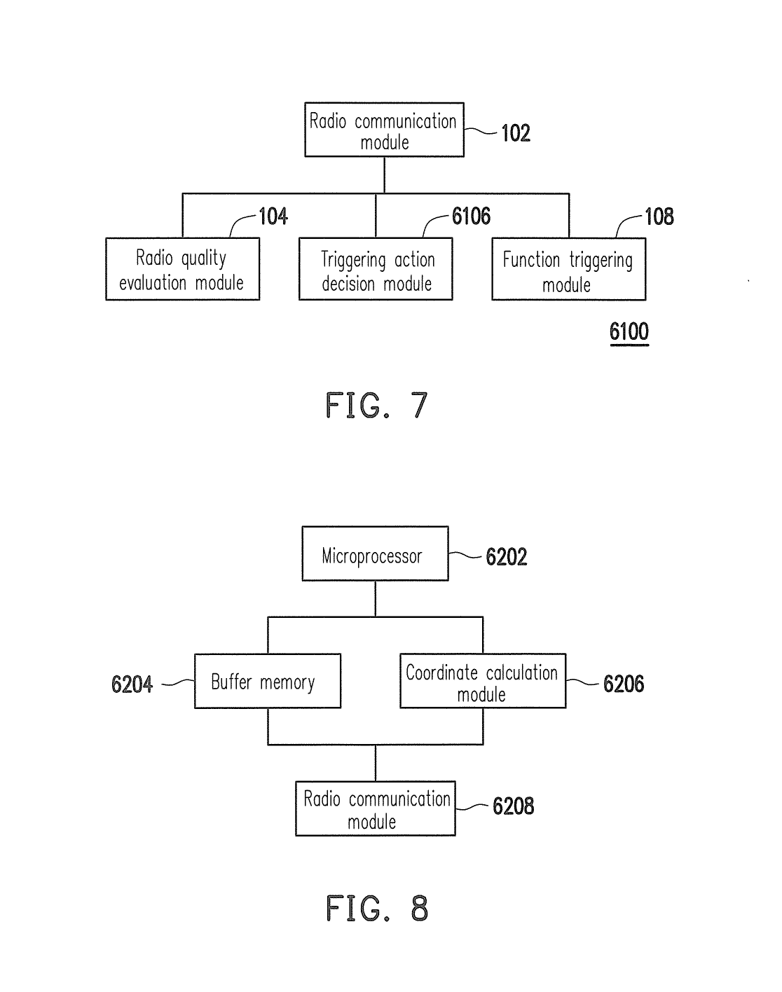

The first electronic device 6100 has the radio communication module 102, the radio quality evaluation module 104, a triggering action decision module 6106 and the function triggering module 108 (as that shown in FIG. 7).

The radio communication module 102 is configured for linking the second electronic device 6200 and receiving radio signals from the second electronic device 6200.

The triggering action decision module 6106 identifies a relative displacement between the second electronic device 6200 and the first electronic device 6100 according to the coordinate information received from the second electronic device 6200, and determines a displacement range corresponding to the relative displacement, so as to drive the function triggering module 108 to set the first electronic device 6100 to a corresponding working mode.

The second electronic device 6200 is configured for sending radio signals to the first electronic device 6100, or the second electronic device 6200 can send information to or obtain information from the first electronic device 6100 through the radio bridge 6302, the radio bridge 6304 and the radio bridge 6306. For example, in the present exemplary embodiment, the second electronic device 6200 is a mobile phone. However, it should be noticed that the present disclosure is not limited thereto, and the second electronic device 6200 can be any portable first electronic device capable of linking to the first electronic device 6100.

The radio bridge 6302, the radio bridge 6304 and the radio bridge 6306 can communicate with the second electronic device 6200 and can transmit respective coordinates to the second electronic device 6200. Alternatively, the second electronic device 6200 can obtain approximate positions of the radio bridge 6302, the radio bridge 6304 and the radio bridge 6306 or locations thereof in the space through decoding the radio signals, measuring the radio signals or looking up a corresponding table based on the radio signals.

FIG. 8 is a block schematic diagram of the second electronic device of the exemplary embodiment of FIG. 6.

Referring to FIG. 8, the second electronic device 6200 has a microprocessor 6202, a buffer memory 6204, a coordinate calculation module 6206 and a radio communication module 6208. The microprocessor 6202 is configured for controlling a whole operation of the second electronic device 6200, the buffer memory 6204 is configured for temporarily storing data, the coordinate calculation module 6206 is configured for calculating coordinates of the second electronic device 6200, and the radio communication module 6208 is configured for receiving and transmitting radio signals.

In the present exemplary embodiment, the coordinate calculation module 6206 of the second electronic device 6200 uses an indoor positioning algorithm to calculate its own coordinates according to the coordinate information received from the radio bridge 6302, the radio bridge 6304 and the radio bridge 6306. For example, the radio bridge 6302, the radio bridge 6304 and the radio bridge 6306 can be set to fixed coordinates. Therefore, the coordinate calculation module 6206 can calculates a distance between itself and the radio bridge 6302 according to the radio signals between the radio communication module 6208 and the radio bridge 6302. Similarly, the coordinate calculation module 6206 may calculate distances between itself and the radio bridge 6304 and the radio bridge 6306. In this way, the coordinate calculation module 6206 may calculate its own coordinates according to the calculated distances and the coordinates of the radio bridges. It should be noticed that in another exemplary embodiment, the second electronic device 6200 can also obtain positions of the radio bridge 6302, the radio bridge 6304 and the radio bridge 6306 or locations thereof in the space through decoding the radio signals, measuring the radio signals or looking up a corresponding table based on the radio signals, so as to obtain information of its own approximate position.

The second electronic device 6200 transmits the calculated coordinates to the first electronic device 6100 through the radio signals. Therefore, the triggering action decision module 6106 sets a corresponding working mode according to the received coordinates.

In the present disclosure, the coordinate calculation module 6206 may be implemented by a hardware circuit or a computer program.

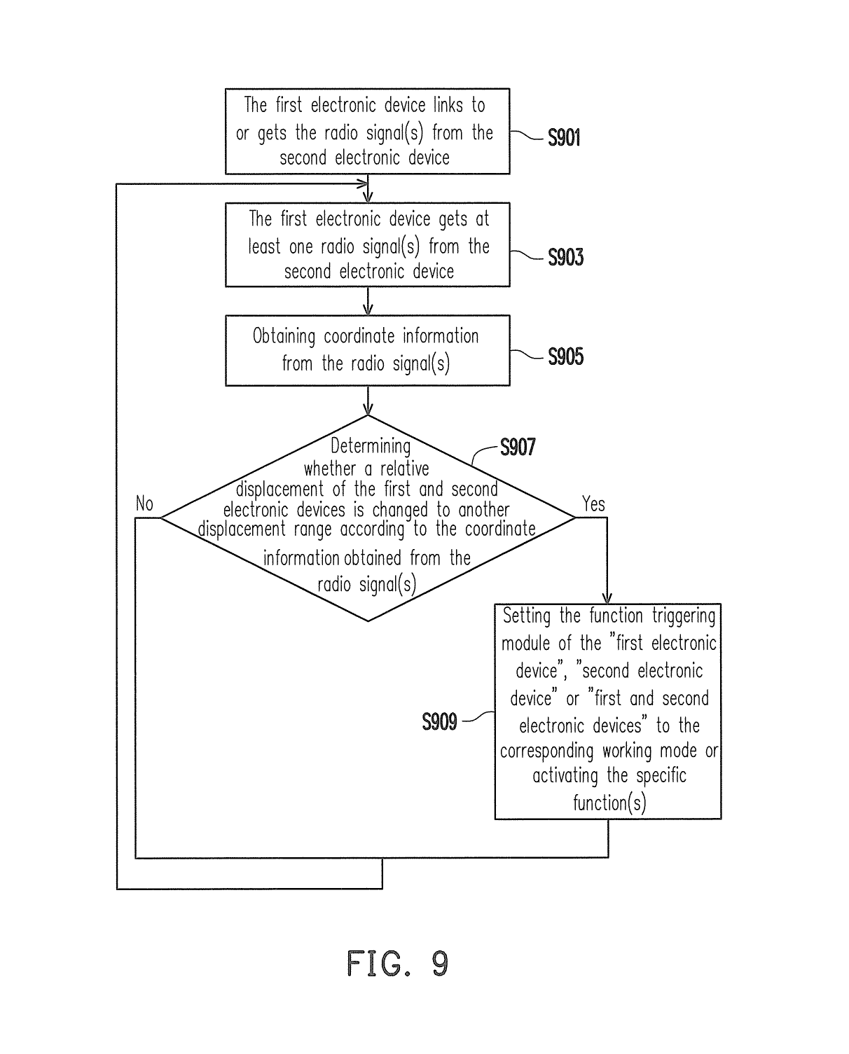

FIG. 9 is a flowchart illustrating a method of triggering a corresponding function of an first electronic device according to the exemplary embodiment of FIG. 6, FIG. 7 and FIG. 8.

Referring to FIG. 9, in step S901, the radio communication module 102 of the first electronic device 6100 is linked to the second electronic device 6200.

Then, in step S903, at least one radio signal is received from the second electronic device 6200. In step S905, coordinate information is obtained from the radio signal(s).

Then, in step S907, it is determined whether a relative displacement of the second electronic device 6200 is changed to another displacement range according to the coordinate information obtained from the radio signal(s).

If the relative displacement of the second electronic device 6200 is changed to another displacement range, in step S909, the function triggering module 108 of the first electronic device 6100 is set to a corresponding working mode.

If the relative displacement of the second electronic device 6200 is not changed to another displacement range, or after the step S909 is executed, the flow is returned to the step S903 to continually receive the radio signal sent by the second electronic device 6200.

In the exemplary embodiment of FIG. 1, the first electronic device directly receives the radio signals from the second electronic device, and enters a corresponding working mode according to the information of the received radio signals (for example, the radio signal strengths, the radio signal beacon time densities or a control command). However, the triggering action decision module may also set the function triggering module to the corresponding working mode or trigger the first electronic device to execute a corresponding function according to a control command sent by the second electronic device.

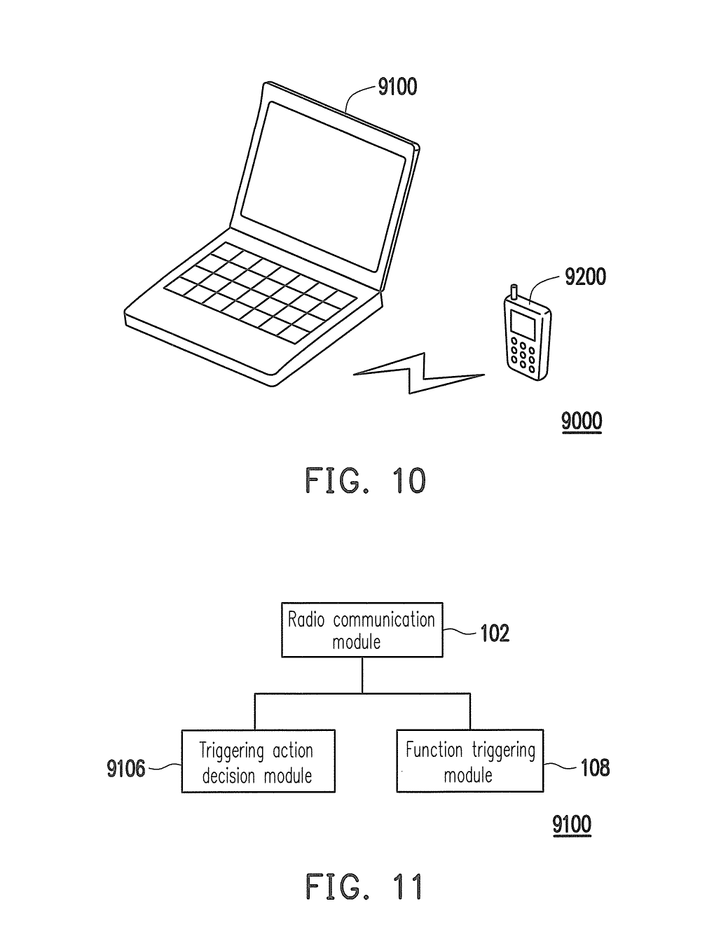

FIG. 10 is a diagram of a system of triggering a corresponding function of an electronic device according to still another exemplary embodiment of the disclosure. FIG. 11 is a block schematic diagram of the first electronic device of the exemplary embodiment of FIG. 10.

Referring to FIG. 10, the system 9000 includes an first electronic device 9100 and a second electronic device 9200. The first electronic device 9100 and the second electronic device 9200 can be mutually communicated. For example, in the present exemplary embodiment, the first electronic device 9100 is a computer, and the second electronic device 9200 is a mobile phone. However, it should be noticed that the present disclosure is not limited thereto.

The first electronic device 9100 includes the radio communication module 102, a triggering action decision module 9106 and the function triggering module 108.

The triggering action decision module 9106 is coupled to the radio communication module 102 and is configured for controlling the function triggering module 108 of the first electronic device 9100 according to a control command received from the second electronic device 9200.

The user may directly use the second electronic device 9200 to send the control command to the first electronic device 9100. Moreover, when the radio communication module 102 of the first electronic device 9100 receives the control command from the second electronic device 9200, the triggering action decision module 9106 identifies the control command, and drives the function triggering module 108 to set a corresponding working mode or activate corresponding software according to the control command.

For example, the control command can be a wakeup control command transmitted to the first electronic device 9100 through a mouse, a keyboard, a wireless network or a cable network. For example, when the first electronic device 9100 is in the sleep mode, and the radio communication module 102 receives the wakeup control command from the second electronic device 9200, the triggering action decision module 9106 drives the function triggering module 108 to set the normal working mode.

For example, the control command instructs to turn off a computer screen. Therefore, when the user leaves the first electronic device 9100, the user can operate the second electronic device 9200 to send the control command instructing to turn off the computer screen to the first electronic device 9100. Moreover, when the radio communication module 102 receives the control command instructing to turn off the computer screen from the second electronic device 9200, the triggering action decision module 9106 instructs the function triggering module 108 to turn off a power of a screen (not shown) of the first electronic device 9100. Alternatively, the triggering action decision module 9106 adjusts a brightness of the screen according to the received control command, or sets the first electronic device 9100 to a power consumption mode.

In the present exemplary embodiment, the radio communication module 102 and the triggering action decision module 9106 can still receive and identify the control commands come from the second electronic device 9200 after the first electronic device 9100 enters the soft off mode.

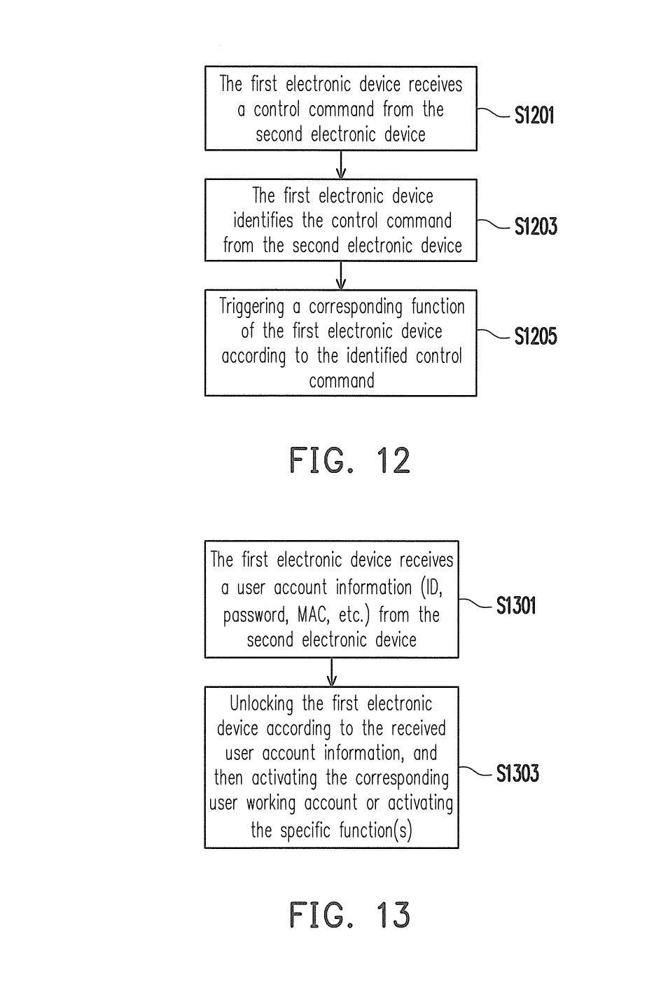

FIG. 12 is a flowchart illustrating a method for triggering a corresponding function of an electronic device according to the exemplary embodiment of FIG. 10 and FIG. 11.

Referring to FIG. 12, in step S1201, a control command is received from the second electronic device. Then, in step S1203, the received control command is identified.

Finally, in step S1205, a corresponding function of the first electronic device is triggered according to the identified control command.

In the exemplary embodiment of FIG. 1 and FIG. 2, the first electronic device directly receives the radio signals from the second electronic device, and enters a corresponding working mode according to the information of the received radio signals (for example, the radio signal strengths, the radio signal beacon time densities or a control command). Moreover, in another exemplary embodiment, the working mode switching module can further identify a user account and a user password sent by the second electronic device or an identification code used for identifying a user identity, so as to automatically lock/unlock the first electronic device or activate a user working account or working mode. The present exemplary embodiment is described with reference of FIG. 1 and FIG. 2.

In the present exemplary embodiment, when the second electronic device 200 departs from the first electronic device 100, the working mode switching module 106a of the triggering action decision module 106 can automatically lock the first electronic device 100. Moreover, when the first electronic device 100 is woken up from the sleep mode (i.e. entering the normal working mode) due to approach of the second electronic device 200, the second electronic device 200 transmits the user account and the user password to the electronic device 100. Moreover, when the radio communication module 102 receives the user account and the user password from the second electronic device 200, the working mode switching module 106a of the triggering action decision module 106 unlocks the first electronic device 100 according to the received user account and user password, and activates the corresponding user working account or working mode.

For example, the working mode switching module 106a of the triggering action decision module 106 can obtain information of the second electronic device 200 (for example, MAC message or information used for identifying the second electronic device 200) by radio. Then, the working mode switching module 106a of the triggering action decision module 106 can automatically login the corresponding user working account or automatically enter the corresponding user working mode.

Moreover, in another exemplary embodiment, the working mode switching module 106a of the triggering action decision module 106 can automatically execute a specific function after unlocking the first electronic device 100. For example, the working mode switching module 106a of the triggering action decision module 106 can automatically activate software (for example, a webpage browser, etc.) or a function (for example, monitoring whether the keyboard or the mouse is used) according to the received user account and user password, so as to serve as a reference for adjusting a monitoring frequency for “a link state between the first electronic device 100 and the second electronic device 200”.

When the aforementioned exemplary embodiments are applied to a computer (a monitoring device 100), it can be detected whether a specific computer device unit is used in a past short period of time or a specific time section to serve as a basis to determine whether the user is near the computer. The specific computer device units include a computer keyboard, a mouse or related device units used for determining that the user is near the computer and uses the computer. When a determination result indicates that the user is near the computer, the computer can change a monitoring frequency, or temporarily reduce or stop monitoring the radio signal quality between the computer and the second electronic device 200, so as to further save the power consumption and a calculation resource required when a related first electronic device executes the method of the disclosure.

For example, in a current operating system, after entering the sleep mode, the first electronic device 100 is automatically in a locking state. Then, after the user wakes up the first electronic device 100, the user account and user password have to be input to unlock the first electronic device 100, so as to continually use the first electronic device 100. In the present exemplary embodiment, after the working mode switching module 106a of the triggering action decision module 106 drives the function triggering module 108 to set the normal working mode according to the radio signal quality evaluation value, it identifies the user account and user password sent by the second electronic device 200 and activates the corresponding user working account or working mode.

FIG. 13 is a flowchart illustrating a method for triggering a corresponding function of an electronic device according to another exemplary embodiment of the disclosure.

Referring to FIG. 13, when the first electronic device 100 enters the normal working mode from the sleep mode, in step S1301, the user account and user password are received from the second electronic device. Then, in step S1303, the first electronic device 100 is unlocked according to the received user account and user password, and the corresponding user working account or working mode is activated.

In summary, according to the method and the system for triggering a corresponding function of the electronic device of the disclosure, a displacement of the user and the electronic device is determined by obtaining characteristic information (for example, the signal strength or the beacon time density) of the radio signals sent by the handheld electronic device of the user for example, so as to guide the electronic device to a suitable working mode. Moreover, according to the method and the system for triggering a corresponding function of the electronic device of the disclosure, the electronic device is triggered to execute a specific function by identifying a control command or coordinate information sent by the handheld electronic device. In this way, the method and the system for the disclosure may reduce power consumption to achieve carbon reduction. Moreover, based on the identification codes (for example, the user account and user password) sent by the handheld electronic device, the method and the system of the disclosure can automatically lock/unlock the electronic device under a safe condition or activate the corresponding user working account or working mode according to the mobile phone information (for example, message information or registration information, etc. of a specific user), so as to facilitate user's utilization.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for triggering a corresponding function of an electronic device, comprising:
detecting a plurality of radio signals between a first electronic device and a second electronic device;
calculating and generating a radio signal quality evaluation value according to a characteristic of the radio signals; and
triggering the first electronic device to execute a corresponding function or triggering to set the first electronic device to one of a plurality of working modes according to the radio signal quality evaluation value.

2. The method as claimed in claim 1, wherein the step of calculating and generating the radio signal quality evaluation value according to the characteristic of the radio signals comprises:
identifying a plurality of radio signal strengths or a plurality of radio signal beacon time densities corresponding to the radio signals; and
generating the radio signal quality evaluation value according to the radio signal strengths or the radio signal beacon time densities corresponding to the radio signals.

3. The method as claimed in claim 1, wherein the step of calculating and generating the radio signal quality evaluation value according to the characteristic of the radio signals comprises:
identifying a plurality of radio signal strengths or a plurality of radio signal beacon time densities corresponding to the radio signals;
calculating a variation trend of the radio signal strengths or a variation trend of the radio signal beacon time densities; and
generating the radio signal quality evaluation value according to the variation trend of the radio signal strengths or the variation trend of the radio signal beacon time densities.

4. The method as claimed in claim 1, further comprising:
receiving a message from the second electronic device, wherein the message comprises a user account, a user password or an identification code; and
unlocking the first electronic device according to the message, or guiding the first electronic device to execute a corresponding function or guiding the first electronic device to enter a user working account or a user working mode according to the message.

5. A method for triggering a corresponding function of an electronic device, comprising:
communicating with or receiving information from at least one second electronic device through a radio bridge by a first electronic device;
receiving coordinate information or information used for obtaining an approximate position from the at one second electronic device;
triggering the first electronic device to execute a corresponding function or triggering to set the first electronic device to one of a plurality of working modes according to the coordinate information or the information used for obtaining the approximate position.

6. A method for triggering a corresponding function of an electronic device, adapted to an electronic device having a radio communication module, and the method comprising:
linking the radio communication module of the electronic device with a radio device;
receiving a control command from the radio device; and
executing a corresponding function of the electronic device according to the control command.

7. The method as claimed in claim 6, wherein the step of executing the corresponding function of the electronic device according to the control command comprises:
waking up the electronic device, turning off a power of a screen of the electronic device, adjusting a brightness of the screen or setting the electronic device to a corresponding power consumption mode.

8. A system for triggering a corresponding function of an electronic device, comprising:
a radio quality evaluation module, is configured to detect a plurality of radio signals between a first electronic device and a second electronic device, wherein the first electronic device and the second electronic device respectively have a radio communication module, and the first electronic device and the second electronic device are linked by radio;
a triggering action decision module; and
a function triggering module, disposed in the first electronic device,
wherein the radio quality evaluation module generates a radio signal quality evaluation value according to a signal characteristic of the radio signals,
wherein the triggering action decision module sets the function triggering module of the first electronic device to one of a plurality of working modes, or guides the first electronic device to execute a corresponding function according to the radio signal quality evaluation value.

9. The system as claimed in claim 8, wherein the radio quality evaluation module identifies a plurality of radio signal strengths or a plurality of radio signal beacon time densities corresponding to the radio signals, and generates the radio signal quality evaluation value according to the radio signal strengths or the radio signal beacon time densities corresponding to the radio signals.

10. The system as claimed in claim 8, wherein the radio quality evaluation module identifies a plurality of radio signal strengths or a plurality of radio signal beacon time densities corresponding to the radio signals, calculates a variation trend of the radio signal strengths or a variation trend of the radio signal beacon time densities, and generates the radio signal quality evaluation value according to the variation trend of the radio signal strengths or the variation trend of the radio signal beacon time densities.

11. The system as claimed in claim 8, wherein the triggering action decision module comprises a working mode switching module for receiving a message from the second electronic device, and unlocking the first electronic device according to the message, or guiding the first electronic device to enter a user working account or working mode according to the message,
wherein the message comprises a user account, a user password or an identification code.

12. The system as claimed in claim 8, further comprising at least one radio bridge,
wherein the at least one radio bridge is configured for transferring the radio signals between the second electronic device and the first electronic device.

13. The system as claimed in claim 9, wherein the first electronic device is a computer,
wherein when the second electronic device and the first electronic device are linked by radio, the working mode switching module processes and records a best radio signal quality between the first electronic device and the second electronic device.

14. The system as claimed in claim 13, wherein when the computer detects that a user uses the computer, the radio quality evaluation module re-measures, updates or records the best radio signal quality between the first electronic device and the second electronic device.

15. The system as claimed in claim 8, wherein the radio quality evaluation module repeatedly detects the radio signals between the first electronic device and the second electronic device according to a monitoring frequency.

16. The system as claimed in claim 15, wherein the radio quality evaluation module adjusts the monitoring frequency according to a measuring result of a G-sensor, a gyro or an E-compass.

17. The system as claimed in claim 15, wherein the radio quality evaluation module adjusts the monitoring frequency according to a signal of a keyboard or a mouse.

18. The system as claimed in claim 8, wherein the radio quality evaluation module and the triggering action decision module are disposed in the first electronic device.

19. The system as claimed in claim 8, wherein the radio quality evaluation module is disposed in the second electronic device, and the triggering action decision module is disposed in the first electronic device.

20. The system as claimed in claim 8, wherein the radio quality evaluation module and the triggering action decision module are disposed in the second electronic device.

21. A system for triggering a corresponding function of an electronic device, comprising:
a first electronic device, comprising:
a radio communication module,
a triggering action decision module; and
a function triggering module;
at least one radio bridge; and
a second electronic device, linked to the radio communication module of the first electronic device through the radio bridge, and generating coordinate information corresponding to the second electronic device or information used for obtaining an approximate position according to a plurality of radio signals from the at least one radio bridge,
wherein the triggering action decision module receives the coordinate information or the information used for obtaining the approximate position from the second electronic device through the radio communication module, and sets the function triggering module of the first electronic device to one of a plurality of working modes or guides the first electronic device to execute a corresponding function according to the coordinate information or the information used for obtaining the approximate position.

22. The system as claimed in claim 21,
wherein the second electronic device has a coordinate calculation module, and the coordinate calculation module calculates the coordinate information corresponding to the second electronic device according to the radio signals received from the at least one radio bridge, coordinate information of the at least one radio bridge or the information used for obtaining the approximate position.

23. A system for triggering a corresponding function of an electronic device, comprising:
a first electronic device, having a radio communication module and a function triggering module; and
a second electronic device, having a triggering action decision module, and linked to the radio communication module of the first electronic device,
wherein the function triggering module receives a control command of the triggering action decision module from the second electronic device through the radio communication module, and execute a corresponding function of the first electronic device according to the control command.

24. The system as claimed in claim 23, wherein the function triggering module instructs the first electronic device to enter a sleep mode, wakes up the first electronic device, turns off a power of a screen of the first electronic device, adjusts a brightness of the screen or sets the first electronic device to a power consumption mode according to the control command.
